(19) United States
(12) Patent Application Publication
(10) Pub. No.: US 2025/0129276 A1
(43) Pub. Date: Apr. 24, 2025

(54) MODIFIED WAX THAT CAN IMPROVE THE ADHESION BETWEEN POLYPROPYLENE AND A METAL SUBSTRATE

(71) Applicant: HONEYWELL INTERNATIONAL INC., CHARLOTTE, NC (US)

(72) Inventors: XUFENG LIU, SHANGHAI (CN); GUANGYAN WANG, SHANGHAI (CN)

(73) Assignee: HONEYWELL INTERNATIONAL INC., CHARLOTTE, NC (US)

(21) Appl. No.: 18/894,116

(22) Filed: Sep. 24, 2024

Related U.S. Application Data
(60) Provisional application No. 63/592,333, filed on Oct. 23, 2023.

(51) Int. Cl. C09J 167/00; C09J 7/28

(52) U.S. Cl. CPC C09J 167/00; C09J 7/28; C09J 2301/122; C09J 2301/408; C09J 2400/163; C09J 2467/00; C09J 2491/00

(57) ABSTRACT

Provided are adhesive compositions comprising a maleated (maleic anhydride modified) polypropylene wax that is combined with a thermoplastic binder polymer, as well as multilayer cap constructions that utilize said adhesive compositions to bond non-toxic polymer liners to the interior surfaces of metal caps. The adhesives have a relatively high melting point and can be used in consumable product packaging applications that are subjected to industry standard, high temperature sterilization procedures.

### CROSS-REFERENCE TO RELATED APPLICATION

This application claims the benefit of co-pending U.S. Provisional Application Ser. No. 63/592,333, filed on Oct. 23, 2023, the disclosure of which is incorporated by reference herein in its entirety.

### BACKGROUND

### Technical Field

The present disclosure generally relates to improved metal cap constructions for packaging human-consumable beverage and/or food products.

### DESCRIPTION OF THE RELATED ART

Many consumable products such as beverages are packaged in bottles or cans that are sealed by caps, such as crown caps. Such caps are usually made of a metal (or metallic) substrate, such as chromed or tinned iron, copper, steel or aluminum, with a polymeric liner being applied to the metal/metallic substrate to avoid contact of the product with the metal. Commonly, the polymeric liners are bonded to the metal/metallic substrate with an intermediate adhesive. There are mainly three types of liner materials currently used: polyvinyl chloride (PVC), polyethylene (PE) and polypropylene (PP). Polyvinyl chloride liners have good adhesion to many commonly used adhesive coatings. However, polyvinyl chloride liners have been gradually eliminated from packaging systems for human consumable products because they often contain plasticizers, such as dioctyl phthalate, which are toxic to humans. Polyethylene liners are non-toxic but they have a low melting point and therefore cannot be used in the packaging of beverages that are sterilized at high temperatures because the liner will soften and delaminate from the cap.

Polypropylene liners generally do not contain plasticizers and are can tolerate sterilization at high temperatures (e.g., 120° C.-130° C.), but polypropylene does not bond well to metal caps when using adhesives that are conventionally used in the industry. To address this problem of a poor bond, it is known to employ a maleic anhydride modified polypropylene as an intermediate adhesive in bonding polypropylene to a metal substrate. For example, U.S. Pat. No. 11,623,792 teaches making lids for rigid food packaging by first manufacturing strips of material that comprise an aluminum alloy substrate coated with a layer of a maleic anhydride modified polypropylene resin adhesive, and a polypropylene surface layer on the adhesive layer. The strips are then shaped into lids suitable for food packaging. U.S. Pat. No. 11,498,316 teaches a composite film for closing containers. The film comprises of a metal substrate and a tie layer made of maleic anhydride modified polypropylene resin, as well as an inner multilayer membrane comprising a polymer such as polypropylene. U.S. Pat. No. 7,419,560 teaches a continuous polymeric coating operation on a metal substrate. The polymeric coating includes thermoplastic polymeric materials such as polypropylene and the disclosure further teaches the use of maleic anhydride modified polypropylene resin as an adhesive. U.S. Pat. No. 5,939,196 teaches a multilayered coating on a metal surface. The multilayers include a primer layer, an adhesive layer, and a thermoplastic layer, wherein the adhesive layer may be a maleic anhydride modified polypropylene resin, and the thermoplastic polymer may be polyethylene or polypropylene.

While all of these approaches have their utility in various applications, it remains that none can tolerate high temperature sterilization without delaminating of the liner on the metal cap. Accordingly, there is a need in the art for an improved adhesive that can firmly adhere polypropylene or other polyolefin liners to metals substrates (such as aluminum or tinplate), which can also tolerate high temperature sterilization without delaminating. The present disclosure provides a solution to this need.

### SUMMARY OF THE DISCLOSURE

This disclosure is particularly directed to adhesive compositions comprising a maleated (maleic anhydride modified) polypropylene wax that is combined with a thermoplastic or thermosetting binder polymer, as well as multilayer cap constructions that utilize said adhesive compositions to bond non-toxic polymeric liners to the interior surfaces of metal caps. More particularly, the disclosure provides an adhesive dispersion comprising:
a) a solution comprising at least one binder polymer dissolved in one or more organic solvents; and
b) a maleic anhydride modified polyolefin wax dispersed in said solution;
wherein said maleic anhydride modified polyolefin wax has a weight average molecular weight of from about 1000 to about 20,000 and has a maleic anhydride grafting ratio of from about 0.05% up to about 8.0%.

Also provided is a multilayered cap comprising:
a) a metal substrate having an inner surface and an outer surface;
b) an intermediate adhesive layer, having first and second surfaces, on the metal substrate with the first surface of the adhesive layer on the inner surface of the metal substrate;
which adhesive layer comprises a combination of at least one thermosetting binder polymer or at least one thermoplastic binder polymer, and a maleic anhydride modified polyolefin wax; and
c) a polymeric liner, having first and second surfaces, on the adhesive layer with the first surface of the liner on the second surface of the adhesive layer.

Still further provided is a process for forming a multilayered cap, comprising:
a) providing a metal substrate, which metal substrate is optionally in the shape of a container cap, said metal substrate having an inner surface and an outer surface;
b) applying an adhesive dispersion onto said inner surface of the metal substrate, said adhesive dispersion comprising:
   i) a solution comprising at least one binder polymer dissolved in one or more organic solvents; and
   ii) a maleic anhydride modified polypropylene wax dispersed in said solution;
   wherein said maleic anhydride modified polyolefin wax has a weight average molecular weight of from about 1000 to about 20,000 and has a maleic anhydride grafting ratio of from about 0.05% up to about 8.0%;
c) heating the adhesive dispersion to remove all or substantially all of said solvent, thereby leaving a cured adhesive composition on the inner surface of said metal substrate, thereby forming an adhesive coated metal substrate; and
d) applying a liner polymer onto said cured adhesive composition, wherein the liner polymer is a thermoplastic polymer, wherein said liner polymer is optionally heated and optionally pressed into said cured adhesive composition, thereby forming a liner on said adhesive coated metal substrate.

### BRIEF DESCRIPTION OF THE DRAWING

FIG. 1 illustrates the shape of a conventional crown cap of the prior art.

### DETAILED DESCRIPTION

In order to achieve a dry adhesive composition having the desired properties while achieving a durable, strong bond to both a metal (or metallic) substrate and a polymeric liner, the first step is to form a dispersion of maleic anhydride modified polyolefin (“MAPO”) wax dispersed in a solution, which solution comprises one or more thermoplastic or thermosetting binder polymers dissolved in one or more organic solvents.

The MAPO waxes used herein differ from maleic anhydride modified polyolefin resins. MAPO waxes, for example, have substantially lower weight average molecular weights than are MAPO resins, wherein the weight average molecular weight of a MAPO wax ranges from about 1000 kg/mol to about 20,000 kg/mol, while the weight average molecular weight of a MAPO resin is greater than 50,000 kg/mol, a substantial difference. Additionally, the MAPO waxes can be prepared into micropowders with much smaller particle sizes compared to MAPP resins. In this regard, MAPO waxes can be easily prepared into particles having an average particle size of ≤30 μm, which is very difficult and generally not possible at commercially viable amounts with MAPO resins due to their relatively high molecular weights and high melt viscosities. Indeed, MAPO waxes can even be prepared into particles having particle sizes of <20 μm, or even <10 μm particle size, which is generally not achievable with MAPO resins. Accordingly, MAPO waxes can also be correspondingly prepared into much thinner films (≤10 μm thick) compared to MAPP resins prepared with such greater particle sizes. Currently, the market demands an adhesive dry film thickness of ≤10 μm, so the particle sizes must be smaller, which is only achievable with the MAPO waxes. As such, the MAPO/MAPP wax dispersions also have a better overall appearance than compositions made with MAPO/MAPP resins because the wax films will be smooth, while attempting to convert large particulate MAPO/MAPP resins into thick films results in rough or bumpy, not smooth liners, which leads to unacceptable bond strength of the adhesive to metal substrate and to the polymer liner, and which also are not aesthetically pleasing.

In one particular embodiment of the disclosure, the MAPO wax is a maleic anhydride modified polypropylene (“MAPP”) wax, which is made by grafting maleic anhydride groups on to a polypropylene homopolymer wax. Such MAPP waxes, also referred to in the art as “maleated polypropylene wax”, have a maleic anhydride grafting ratio of 8.0 weight % or less, preferably from about 0.05 weight % up to about 8.0%, more preferably from about 1.0 weight % to about 5.0 weight %, or in other embodiments, 2.0 weight % or less, or 1.0 weight % or less. Such grafting ratios are similarly preferred for other maleic anhydride modified polyolefin waxes, such as maleic anhydride modified polyethylene wax. The MAPO wax is also preferably a micronized particulate wax, wherein the wax comprises particles having average particle size of from about 4 μm to about 30 μm, more preferably from about from about 5 μm to about 20 μm and most preferably from about 6 μm to about 10 μm. Suitable MAPO and MAPP micronized particulate waxes having such preferred particle sizes and grafting ratios are commercially available, for example, from Honeywell International Inc. of Charlotte, North Carolina under their ACUMIST® brand of micronized polyolefin waxes.

When forming the adhesive dispersions of this disclosure, any conventionally known organic solvent may be used, which non-exclusively include ester-based solvents, such as methyl acetate, ethyl acetate, propyl acetate and butyl acetate; ketone-based solvents, such as acetone, methyl ethyl acetone and cyclohexanone; aliphatic hydrocarbons, such as hexane, cyclohexane, octane, nonane, decane, undecane, dodecane and mineral spirits; aromatic hydrocarbons, such as benzene, toluene, xylene, naphthalene, and solvent napthta; alcohols, such as methanol, ethanol, tert-butanol, iso-propanol (2-propanol); alcohol ether solvents such as ethylene glycol monoalkyl ethers; cyclic ethers, such as tetrahydrofuran, tetrahydropyran, and dioxane; ether esters such as propylene glycol monomethyl ether formate, propylene glycol monomethyl ether acetate, propylene glycol monomethyl ether propionate, propylene glycol monomethyl ether butyrate, propylene glycol monoethyl ether formate, propylene glycol monoethyl ether acetate, propylene glycol monoethyl ether propionate and propylene glycol monoethyl ether butyrate; terpene solvents, such as eucalyptol, limonene, pinene and menthone; dimethyl sulfoxide; and the mixtures thereof. Also potentially useful are halogenated solvents, e.g., chlorinated solvents such as di-chloromethane and tri-chloromethane, but those are not preferred due to environmental safety concerns. Each of these solvents are commercially available. For example, particularly useful solvents non-exclusively include Solvesso™ brand solvents from ExxonMobil Chemical Co. of Clark, New Jersey, such as Solvesso™ 150 ND, as well as dibasic ester (DBE), which is commercially available, for example, from G.J. Chemical Company of Newark, New Jersey.

As stated herein, the MAPO wax is dispersed in a solution that comprises at least one binder polymer that is dissolved in said one or more organic solvents. The at least one binder polymer forming said solution may generally comprise any thermoplastic or thermosetting polymer that can be fully dissolved by an organic solvent. Suitable thermosetting polymers non-exclusively include thermosetting polyesters, particularly hydroxyl functional polyester resins as well as low viscous oil free polyester resins commercially available from Allnex GmbH of Frankfurt am Main, Germany; epoxies, including solvent-free liquid epoxy resins also available from Allnex GmbH; acrylic polymers, including hydroxy functional acrylic resins also available from Allnex GmbH; alkyd polymers, including non-drying, short oil alkyds based on synthetic fatty acid, which are also available from Allnex GmbH; as well as amino polymers and phenolic polymers that are mainly used as crosslinking agents, including methylated, monomeric melamine crosslinkers (amino polymers) and curable phenolic resins, each of which are also available from Allnex GmbH. Also suitable are combinations of any of said thermosetting polymers. Suitable thermoplastic polymers are those which are dissolvable in solvents at room temperature, which non-exclusively includes acrylic polymers and polyesters. The binder polymer may also be polar or non-polar, but if the polymer(s) are polar, the solvent(s) must be polar to properly dissolve the polymer(s), and if the polymer(s) are non-polar, the solvent(s) must be non-polar in order to properly dissolve the polymer(s). All of the thermoplastic and thermosetting polymers suitable for use herein are commercially available.

The solution of the at least one binder polymer and the one or more organic solvents is preferably formed prior to their being combined with the MAPO, wherein the at least one binder polymer is preferably fully dissolved in one or more organic solvents to form a homogenous solution, followed by adding the MAPO to the solution. In another embodiment, all three components, i.e., (1) the at least one binder polymer, (2) the one or more organic solvents, and (3) the MAPO wax, may be combined together prior to the at least one binder polymer being fully or even partially dissolved in the one or more organic solvents. However, it is most preferred that a homogenous solution is first formed followed by adding the MAPO wax to the homogenous solution. In either embodiment, the components may be combined in a suitable mixing vessel with or without agitation, as would be determined by one skilled in the art, with the components being added to the vessel either continuously or batch-wise. The solution is preferably formed at room temperature (e.g., 20° C.-22° C.), but dissolution of the at least one binder polymer may optionally be accelerated by heating the binder polymer(s) and/or the organic solvent(s) to a temperature ranging from about 40° C. to about 140° C. If heated, it is preferred that the solution is pre-heated prior to adding the MAPO wax to the mixing vessel, and then cooled, if necessary, prior to adding the MAPO wax to the vessel to ensure that the temperature of the solution is below the dissolution temperature of the MAPO wax so that the wax it is not dissolved and remains in the form of a micronized powder. Most preferably, the solvent is not pre-heated for making the solution and a homogenous solution is formed with both the at least one binder polymer and the one or more solvents maintained at room temperature (e.g., 20° C.-22° C.).

In the thus formed solution, the at least one binder polymer preferably comprises from about 20% by weight to about 90% by weight of the solution, more preferably from about 30% by weight to about 80% by weight of the solution and most preferably from about 40% by weight to about 70% by weight of the solution, and preferably wherein the at least one binder polymer is at least one thermosetting polymer, most preferably wherein the at least one binder polymer is a single thermosetting polyester, such as, for example, Duroftal® brand polyester resins, which are commercially available from Allnex GmbH. The balance of the solution is the one or more organic solvents.

In the most preferred embodiment, the micronized MAPO wax is added after formation of a homogeneous solution. Unlike the at least one binder polymer, the MAPO wax will not dissolve in the organic solvent(s) forming said solution, but rather will remain suspended in its micronized particulate form in the solution, thereby forming a fine dispersion in the solution. Any suitable mixing vessel may be used to form the dispersion as may be determined by one skilled in the art, but the dispersion is preferably formed in a vessel equipped with a high-speed disperser for best results. Suitable high speed dispersers are conventionally known and readily commercially available.

The MAPO wax may be added to the solution in the mixing vessel either continuously or batch-wise, and the components are combined so that the MAPO wax comprises from about 1 weight % to about 8 weight %, more preferably from about 2 weight % to about 7 weight %, most preferably from about 3 weight % to about 6 weight %, based on the combined weights of all the components forming the dispersion. The solvent(s) will comprise from about 10 weight % to about 80 weight %, more preferably from about 20 weight % to about 70 weight %, most preferably from about 30 weight % to about 60 weight %, based on the combined weights of all the components forming the dispersion. The at least one binder polymer (thermosetting or thermoplastic) will comprise from about 10 weight % to about 80 weight %, more preferably from about 20 weight % to about 70 weight %, most preferably from about 30 weight % to about 60 weight %, based on the combined weights of all the components forming the dispersion.

The components are preferably mixed for about 30 to about 120 minutes, more preferably about 45 to about 105 minutes and most preferably for about 60 to about 90 minutes. Preferably, the solution is maintained at room temperature (e.g., 20° C.-22° C.) prior to adding the MAPO wax and during mixing/dispersion of the wax, but the solution may optionally be heated and maintained at a temperature ranging from about 40° C. to about 140° C. Mixing of the MAPO wax and the solution within a vessel equipped with a high-speed disperser creates a fine, uniform dispersion. This uniform dispersion will have a viscosity ranging from about 300 cps to 3000 cps.

The dispersion itself has adhesive properties, but after being applied for its intended application, it will ultimately be dried to remove all (100%) or substantially all (i.e., no more than 1% by weight solvent remaining) of said solvent, thereby forming a dried adhesive composition that has a very strong bond to both a metal substrate as well as to layers of other polymeric films/polymer layers. Further, if the binder polymer is thermosetting, the polymer will be cured during the drying process or will subsequently be cured with heat, such as by heating/baking the coating in any suitable oven as would be determined by one skilled in the art under conventional curing conditions.

Once dried, with all of the solvent being completely evaporated, and optionally cured if the binder is thermosetting, the MAPO wax comprises from about 2 weight % to about 12 weight % of said dry adhesive composition, more preferably from about 2.5 weight % to about 9 weight %, and most preferably from about 3 weight % to about 6 weight %, and the thermosetting/thermoplastic binder polymer comprises from about 10 weight % to about 80 weight % of said dry adhesive composition, more preferably from about 20 weight % to about 70 weight %, and most preferably from about 30 weight % to about 60 weight %. Therefore, in the final dispersion, the weight ratio of the at least one binder polymer to the MAPO wax is from about 40:1 to about 40:8, more preferably from about 30:1 to about 30:4, and most preferably from about 20:1 to about 20:2.

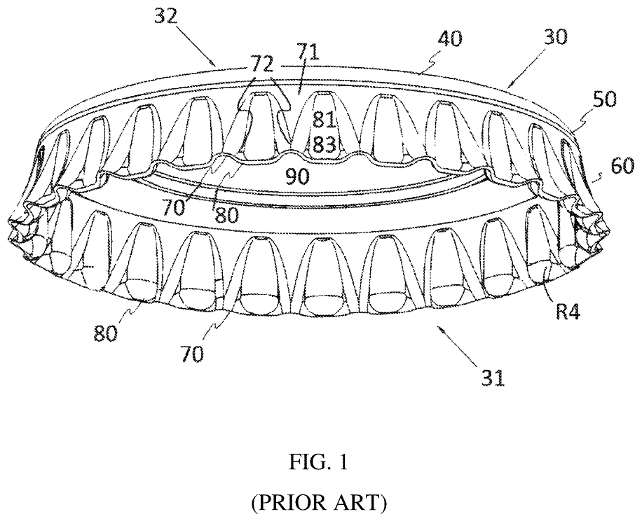

In the preferred embodiments of this disclosure, the metal substrate may be any metal that can be suitably shaped into a lid or cap for a container or bottle, including conventionally known crown caps (also known as “crown cork” or “crown seal”), such as illustrated in, for example, U.S. Pat. No. 2,063,454 or more recently in U.S. Pat. No. 11,124,333, each of which is incorporated herein by reference to the extent consistent herewith. Crown caps are their methods of manufacture are very well known, having been invented in 1892. A generic crown cap such as illustrated in U.S. Pat. Nos. 2,063,454 and 11,124,333 has a corrugated-flange edge forming a number of “ribs” or “teeth” and has been so named because it resembles an inverted crown, and they are designed to be easily twisted or pried off of a bottle top, such as with a bottle opener. In this regard, FIG. 1 of this disclosure shows the shape of a conventional crown cap as illustrated in FIG. 4a of U.S. Pat. No. 11,124,333. However, the metal substrates of this disclosure may be fabricated into caps of any other design as well and the application is not limited to crown caps with such a corrugated-flange edge. The metal substrate may comprise any suitable metal, such as aluminum, tinplate, copper, cast iron, steel, galvanized steel, stainless steel, or an alloy or combination thereof. The term “metallic” refers to compositions that are not 100% pure metals but which contain metal, as well as materials, such as tinplate, which are not a single elemental metal. Tinplate, for example, is a metallic substrate that comprises a thin steel sheet with a coating of tin on each of its surfaces that is applied by electrolytic deposition. Tinplate and its methods of manufacture are conventionally known in the art. As described in this disclosure and as used in the claims of this disclosure, a “metal” substrate is defined to include such “metallic” substrates.

In the preferred embodiments of this disclosure, the metal substrate may have a thickness of from about 100 μm to about 600 μm, more preferably from about 150 μm to about 500 μm and most preferably from about 200 μm to about 400 μm. Suitable metal substrates having such thicknesses are commercially available in sheet form, for example, from Crown Packaging International of Merrillville, Indiana.

In accordance with this disclosure, the adhesive dispersion is applied onto a surface of the desired metal substrate (e.g., in the form of either a sheet or strip of the metal substrate, or in a crown/cap shaped form) and allowed to dry, thereby forming a layer of dry adhesive on the metal substrate. Any appropriate application method may be utilized to apply the adhesive dispersion onto the metal substrate and particular use of a term such as “coated” is not intended to limit the method by which it is applied onto the substrate. Useful methods include, for example, spraying, extruding, roll coating and gravure coating, as well as other techniques such as through a slot-die coating, Meyer rod and air knife coating systems, each of which are well known in the art. The method of applying the adhesive dispersion to the metal substrate is not intended to be limiting. The most preferred method is roll coating. Once dried/cured, the layer of dry adhesive will have a thickness of from about 3 μm to about 20 μm, more preferably from about 4 μm to about 15 μm and most preferably from about 5 μm to about 10 μm.

Thereafter, in accordance with this disclosure, a polymeric liner is to be applied onto or formed on the substrate, with the layer of dry adhesive layer being positioned between the polymeric liner and the metal substrate, forming a multilayered cap structure. In this regard, the metal substrate has an inner surface and an outer surface; the intermediate adhesive layer has first and second surfaces and is on the metal substrate wherein the first surface of the adhesive layer is on the inner surface of the metal substrate; the formed polymeric liner also has first and second surfaces and is on the adhesive layer such that the first surface of the liner is on the second surface of the adhesive layer.

Similar to the binder polymer, the polymeric liner is formed from a liner polymer that may comprise one or more thermosetting polymers or one or more thermoplastic polymers, but in the most preferred embodiments a thermoplastic polymer is used. Suitable thermoplastic polymers non-exclusively include polyolefins, such as polyethylene and polypropylene. The most preferred thermoplastic polymer for forming the polymeric liner is polypropylene due to its relatively high melting point.

Like the adhesive, the polymeric liner may also be applied onto the second surface of the dried/cured adhesive layer metal substrate using any conventional method in the art, and it may be applied either before or after the metal substrate is shaped into the form of a cap (e.g., a crown cap). For example, in one embodiment, the liner polymer is applied by depositing a desired amount of molten thermoplastic polymer onto a pre-shaped crown cap that has been pre-coated with the adhesive dispersion, which adhesive has been dried/cured. The deposited molten polymer may optionally be pressed into the cap, such as with a shaped weight, mandrel or other suitable tool, to press it into the desired liner form on the cap. The polymer is then allowed to fully dry to complete the fabrication of the multilayered cap.

In a more preferred embodiment of this disclosure, both the adhesive dispersion and the polymeric liner are sequentially applied onto a sheet or strip of an unshaped metal substrate, followed by shaping the substrate into the desired cap form (e.g., a crown cap). In this regard, the adhesive dispersion is applied and dried/cured as previously discussed, followed by applying the desired liner polymer onto the dried/cured adhesive. The liner polymer may be applied either in liquid or solid (molten, softened or un-softened (hard)) form using any conventional coating method as is well-known in the art, which are generic in the art. In a typical process, a desired amount of the liner polymer is extruded into a pre-formed crown cap, and the polymer is thereafter pressed and flattened in its molten state to form the liner. Alternatively, the liner polymer may be applied in particulate (e.g., powder) or granular form, followed by softening or melting the particles/granules with heat, followed by flattening the softened/molten polymer into layer form. If the liner polymer is thermoplastic, it is then allowed to cool to room temperature. If the liner polymer is thermosetting, after being applied to the metal substrate it is preferably fully dried/cured in a suitable drying/curing chamber, such as an oven, that is heated to the desired temperature. A typical drying/curing temperature is typically from about 100° C. to about 300° C., more preferably from about 150° C. to about 250° C., with drying/curing times ranging from about 5 minutes to 30 minutes. These drying/curing conditions will vary depending on the particular liner polymer being used and therefore are not intended to be strictly limiting. Once fully dried/cured, the coated substrate should be allowed to fully cool, followed by shaping the coated substrate into the desired cap shape (e.g., a crown cap) using conventional methods.

In the preferred embodiments of this disclosure, the adhesive dispersion is first coated onto the unshaped metal substrate, followed by curing the adhesive, and thereafter the metal substrate is shaped to cap form. Then, after the substrate is shaped into the cap form, the liner polymer is applied into the cap.

Irrespective of the application method or whether the liner polymer is applied to a pre-shaped cap or to an unshaped, planar metal substrate, the polymer liner as applied and dried/cured will have a thickness of from about 3 μm to about 2000 μm, more preferably from about 20 μm to about 600 μm and most preferably from about 50 μm to about 300 μm.

It should also be understood that the adhesive dispersion and binder polymers may further contain conventional additives such as wetting and/or leveling agents, such as octylphenoxypolyethoxyethanol; pigments such as titanium dioxide; cross-linking agents (for thermosetting polymers) such as polyisocyanate, melamine resins, phenolic resins, polyepoxy, and polyanhydride; wetting agents, such as silicone surface additives commercially available from BYK-Chemie GmbH of Wesel, Germany; leveling agents such as polyacrylate solutions also commercially available from BYK-Chemie GmbH. Such additives are blended with the respective polymers/compositions using techniques that are conventionally known in the art.

The following examples serve to illustrate the preferred embodiments:

### Example 1

Eighteen grams (18 g) of xylene and 18 g of Solvesso™ 150 ND naphtha (petroleum), heavy aromatic solvent were charged to a small tinplate can and thoroughly mixed to form a homogenous solvent mixture. Next, 48 g of polyester resin (linear, oil free, saturated polyester resin) and 16 g of melamine resin were added to the vessel and the mixture was stirred until the polyester and melamine were fully dissolved and evenly mixed to form a homogenous solution.

Next, 5 g of a maleated polypropylene micropowder wax was dispersed in the polyester-melamine solution with a high-speed disperser (VMA DISPERMAT® CV3-PLUS disperser). The proportion of wax added was 5 percent by weight based on the weight of the polyester-melamine solution. The fineness of the dispersion was checked until the powder wax was well-dispersed in the solution and the fineness of the dispersion was below 20 μm. This was monitored with a VF2112 grindometer from TQC Sheen of Metamora, MI.

The dispersion was then coated onto a flat tinplate substrate and the coating was then dried in an oven at 185° C. for approximately 10 minutes, yielding a dry film having a thickness of 10 μm on the tinplate substrate. This baking cured the coating by crosslinking the polyester resin and the melamine resin of the adhesive solution.

The coated tinplate was then allowed to completely cool. Thereafter, several polypropylene granules (about 6 to 15 granules) each having a diameter of from about 2 mm to 5 mm were placed on the dried film on the tinplate and together they were transferred to an oven where they were heated at 200° C. for approximately 3 minutes to soften the granules. Thereafter, the softened granules were manually pressed with a standard weight toward the tinplate substrate surface, thereby flattening the polypropylene granules into a flat liner with the dry adhesive dispersion functioning as an intermediate adhesive layer between the polypropylene and the surface of the tinplate substrate. Finally, the propylene lined tinplate was removed from the oven and allowed to cool completely.

The adhesion between the polypropylene liner and the coating was then tested using the following ratings:

| Rating | Description |
|---|---|
| 0 | No adhesion, very easy to peel off. |
| 1 | Just a little adhesion, easy to peel off. |
| 2 | Some adhesion, but still easy to peel off. |
| 3 | Good adhesion, not easy to peel off. |
| 4 | Good adhesion, difficult to peel off. |
| 5 | Very good adhesion, very difficult to peel off. |

A control sample without any maleated polypropylene micropowder wax in the adhesive composition exhibited no adhesion and had an adhesion rating of 0 as per the above scale. Samples prepared in accordance with Example 1 including the micronized, maleated (i.e., maleic anhydride modified) polypropylene wax in the adhesive composition showed a marked adhesive improvement, having very good adhesion and scoring an adhesion rating of 5 on the above scale.

While the present disclosure has been particularly shown and described with reference to preferred embodiments, it will be readily appreciated by those of ordinary skill in the art that various changes and modifications may be made without departing from the spirit and scope of the disclosure. It is intended that the claims be interpreted to cover the disclosed embodiment, those alternatives which have been discussed above and all equivalents thereto.

What is claimed is:

1. An adhesive dispersion comprising:
a) a solution comprising at least one binder polymer dissolved in one or more organic solvents; and
b) a maleic anhydride modified polyolefin wax dispersed in said solution;
wherein said maleic anhydride modified polyolefin wax has a weight average molecular weight of from about 1000 to about 20,000 and has a maleic anhydride grafting ratio of from about 0.05% up to about 8.0%.

2. The adhesive dispersion of claim 1 wherein said maleic anhydride modified polyolefin wax is a maleic anhydride modified polypropylene wax.

3. The adhesive dispersion of claim 2 wherein said maleic anhydride modified polyolefin wax is micronized and has an average particle size of from about 4 μm to about 30 μm.

4. The adhesive dispersion of claim 1 wherein said at least one binder polymer comprises a thermosetting polymer, which thermosetting polymer comprises a polyester, an epoxy, an acrylic polymer, an amino polymer, an alkyd polymer, a phenolic polymer, or a combination thereof, and wherein said at least one organic solvent comprises an aromatic solvent, an ester-based solvent, a ketone-based solvent, an aliphatic hydrocarbon solvent, a terpene solvent, an alcohol, an alcohol ether, an ether ester or a combination thereof.

5. The adhesive dispersion of claim 1 wherein said adhesive comprises a thermosetting polyester.

6. The adhesive dispersion of claim 1 wherein said thermosetting polymer comprises from about 20% by weight % to about 60% by weight of said solution.

7. The adhesive dispersion of claim 6 wherein said maleic anhydride modified polyolefin wax comprises from about 1 weight % to about 6 weight % of said dispersion.

8. A dried or cured adhesive composition comprising the adhesive dispersion of claim 1 wherein all or substantially all of said solvent has been removed.

9. A multilayered cap comprising:
a) a metal substrate having an inner surface and an outer surface;
b) an intermediate adhesive layer, having first and second surfaces, on the metal substrate with the first surface of the adhesive layer on the inner surface of the metal substrate;
which adhesive layer comprises a combination of at least one thermosetting binder polymer or at least one thermoplastic binder polymer, and a maleic anhydride modified polyolefin wax; and
c) a polymeric liner, having first and second surfaces, on the adhesive layer with the first surface of the liner on the second surface of the adhesive layer.

10. The multilayered cap of claim 9 wherein said adhesive comprises said thermosetting binder polymer, wherein said thermosetting binder polymer comprises a polyester and wherein said maleic anhydride modified polyolefin wax comprises a maleic anhydride modified polypropylene wax.

11. The multilayered cap of claim 10 wherein said maleic anhydride modified polypropylene wax has a grafting ratio of from about 0.05% up to about 8.0%.

12. The multilayered cap of claim 11 wherein said maleic anhydride modified polypropylene wax has a weight average molecular weight of from about 1000 to about 20,000.

13. The multilayered cap of claim 12 wherein said maleic anhydride modified polyolefin wax comprises from about 2 weight % to about 12 weight % of said adhesive layer.

14. The multilayered cap of claim 9 wherein said metal substrate comprises aluminum, tinplate, copper, cast iron, steel, galvanized steel, stainless steel, or an alloy or combination thereof.

15. The multilayered cap of claim 9 wherein said polymeric liner comprises said thermoplastic binder polymer, wherein said thermoplastic binder polymer comprises a polyolefin.

16. The multilayered cap of claim 15 wherein said polyolefin comprises polypropylene.

17. The multilayered cap of claim 14 wherein said adhesive layer has a thickness of from about 3 μm to about 20 μm.

18. The multilayered cap of claim 17 wherein said polymeric liner has a thickness of from about 30 μm to about 2000 μm.

19. A process for forming a multilayered cap, comprising:
a) providing a metal substrate, which metal substrate is optionally in the shape of a container cap, said metal substrate having an inner surface and an outer surface;
b) applying an adhesive dispersion onto said inner surface of the metal substrate, said adhesive dispersion comprising:
i) a solution comprising at least one binder polymer dissolved in one or more organic solvents; and
ii) a maleic anhydride modified polypropylene wax dispersed in said solution;
wherein said maleic anhydride modified polyolefin wax has a weight average molecular weight of from about 1000 to about 20,000 and has a maleic anhydride grafting ratio of from about 0.05% up to about 8.0%;
c) heating the adhesive dispersion to remove all or substantially all of said solvent, thereby leaving a cured adhesive composition on the inner surface of said metal substrate, thereby forming an adhesive coated metal substrate; and
d) applying a liner polymer onto said cured adhesive composition, wherein the liner polymer is a thermoplastic polymer, wherein said liner polymer is optionally heated and optionally pressed into said cured adhesive composition, thereby forming a liner on said adhesive coated metal substrate.

20. The process of claim 19 wherein said metal substrate is unshaped as provided in step a) and wherein the process further comprises shaping the metal substrate into the shape of a container cap.
